(19) United States
(12) Patent Application Publication
(10) Pub. No.: US 2022/0098684 A1
(43) Pub. Date: Mar. 31, 2022

(54) Method for Bleaching Sugar With Effluent Recycling

(71) Applicant: Novasep Process Solutions, Saint-Maurice-de-Beynost (FR)

(72) Inventors: François Rousset, Lyon (FR); Annick Merrien, Villeurbanne (FR)

(21) Appl. No.: 17/430,138

(22) PCT Filed: Feb. 28, 2020
(86) PCT No.: PCT/FR2020/050405

§ 371 Date: Aug. 11, 2021

(30) Foreign Application Priority Data
Mar. 4, 2019 (FR) 1902207

(51) Int. Cl. C13B 20/08; B01J 49/57; B01D 61/02; B01J 49/60; B01D 9/00; B01J 41/12; C13B 20/14; C13B 30/02

(52) U.S. Cl. CPC C13B 20/08; B01J 49/57; B01D 61/027; B01J 49/60; B01D 2315/16; B01J 41/12; C13B 20/146; C13B 30/028; B01D 2009/0086; B01D 9/0018

(57) ABSTRACT

The invention relates to a method for treating sugar comprising: placing a coloured sugar juice in contact with an ion exchange resin so as to charge the resin with colouring agents and to collect a bleached sugar juice; regenerating the colouring-charged resin, comprising: placing the charged resin in contact with a regeneration brine comprising a chloride salt; and collecting a regeneration effluent, the regeneration effluent comprising at least three fractions A, B and C, fraction A having a higher concentration of chloride salt than fractions B and C; and recycling the regeneration effluent, comprising: nanofiltration of fraction A of the regeneration effluent in order to obtain a first permeate and a first retentate; diafiltration of the first retentate, said diafiltration comprising: dilution of the first retentate with the fraction B of the regeneration effluent; nanofiltration of the mixture in order to obtain a second permeate and a second retentate; mixing of the first permeate with the second permeate and fraction C of the regeneration effluent,

### FIELD OF THE INVENTION

The present invention concerns a method for treating sugar, comprising steps of decolorizing a sugar juice on an ion exchange resin. The method also comprises steps of regenerating the resin and steps of recycling the effluent used to regenerate the resin.

### TECHNICAL BACKGROUND

The sugar industry produces sugar juice or sugar liquor comprising impurities and colorants in particular. The sugar juice must therefore undergo purification and particularly decolorization.

In one conventional decolorization method, the sugar juice is passed over an ion exchange system packed with an ion exchange resin in particular of strong anionic resin type, and in particular in chloride form. The mechanisms for the fixing of colorants onto ion exchange resins are multiple and involve ion exchange between some colorants of organic acid type and the ions of the resin, as well as the adsorption of hydrophobic colorants on the resin matrix. After the resin has become saturated with colorants, resin regeneration can be obtained by percolating a volume of a salt solution called “regenerant brine” at relatively high concentration and at a pH of 9 to 13. During regeneration, only a small fraction of the chloride ions contained in the regenerant brine is effectively exchanged with the resin i.e. about 5%. Therefore, on completion of the regeneration process, regeneration effluents are recovered comprising about 95% of the chloride ions and colorants. These effluents are more diluted than the initial regenerant brine.

However, the efficacy of regeneration depends on the chloride ion concentration of the regenerant brine, which is preferably in the region of 100 g/L.

Regeneration effluents loaded with salt and optionally colorants are highly polluting since they are very difficult to degrade as such. However, the colorants are degradable with biological treatment provided they have been separated from the salt. In addition, the colorants can also be incorporated in the molasses formed throughout sugar production, again provided they have been separated from the salt.

Separation of the colorants and chloride ions can be performed by nanofiltration owing to the size difference between the salt and the macromolecules of the colorants.

It is known from the introduction to document FR 3005428 to select the most concentrated fraction of regeneration effluent having a salt titre of the order of 80 g/L, which represents about 80% to 90% of the salt contained in the effluent. This fraction is treated by nanofiltration. By means of this nanofiltration, the colorants are concentrated 10 to 15 times in the nanofiltration retentate derived from this fraction with the highest salt concentration. Most of the salt passes through the nanofiltration membrane and is therefore found in the nanofiltration permeate which is used as a base for the following regeneration of the ion exchange resin.

The chloride ion concentration of the nanofiltration permeate is then increased from 80 to 100 g/L through the addition of fresh concentrated brine (e.g. from 250 to 300 g/L) and can again be used as regenerant brine.

This method makes it possible to recycle about 80% of the salt. The fraction of the nanofiltration retentate rich in colorants is mixed with the diluted fractions of the regeneration effluent and treated at a wastewater treatment plant. However, this method has the drawback that a large fraction of the regeneration effluent with low chloride ion concentration is lost.

Additionally, standards are applicable that are increasingly more restrictive concerning discharges into effluents, and it is therefore sought to obtain maximum limiting of the volume of effluents to be treated.

It is also known, in particular from the Novasep brochure titled “High Quality Cane Sugar, Cost-Effective Process Solutions for Mills and Refineries” to collect larger fractions of regeneration effluent to separate the colorants from the salt by nanofiltration.

In this case, a larger fraction of the regeneration effluent is sent to an atmospheric tower before undergoing nanofiltration. A preconcentration is thereby carried out before nanofiltration. This technique makes it possible to obtain a salt recovery rate of approximately 92%.

Alternatively, according to another technique described in this same brochure, a fraction of the regeneration effluent is treated by nanofiltration and the nanofiltration permeate is then mixed with other fractions of the regeneration effluent. This mixture is subjected to evaporation to reduce and adjust the quantity of water. This technique allows a salt recovery rate of approximately 95%.

Document FR 3 005 428 describes a method for recycling a regeneration effluent comprising chloride ions, the method comprising at least one electrodialysis step.

This document mentions a certain number of disadvantages related to concentration techniques. The document mentions that these techniques have high energy costs since they imply considerable consumption of steam to evaporate a large quantity of water.

There is therefore a need to provide an improved method for treating sugar allowing more efficient recovery of chloride ions on the one hand and colorants on the other hand, from a regeneration effluent, the chloride ions being used for regeneration, and the colorants being able to be treated or optionally incorporated in molasses to limit the amount of polluting components, water consumption and the cost of the different steps of the method.

### SUMMARY OF THE INVENTION

The invention concerns a method for treating sugar comprising:

placing a colored sugar juice in contact with an ion exchange resin to charge the resin with colorants and to collect a decolorized sugar juice;

regenerating the colorant-charged resin, comprising:
placing the charged resin in contact with a regenerant brine comprising a chloride salt; and
collecting a regeneration effluent, the regeneration effluent comprising at least three fractions A, B and C, fraction A having a higher chloride salt concentration than fractions B and C; and

recycling the regeneration effluent, comprising:
nanofiltration of fraction A of the regeneration effluent to obtain a first permeate and a first retentate;
diafiltration of the first retentate, this diafiltration comprising:
   dilution of the first retentate with fraction B of the regeneration effluent;
   nanofiltration of the mixture to obtain a second permeate and a second retentate;
mixing the first permeate with the second permeate and with fraction C of the regeneration effluent, and evaporating this mixture to obtain a final fraction; and
using the final fraction to provide a regenerant brine.

In some embodiments, the chloride salt is selected from among sodium chloride, potassium chloride and mixture thereof.

In some embodiments, the method further comprises at least one crystallization step of the decolorized sugar juice, during which vapor is formed which is then used to perform the evaporation step of the mixture of the first permeate with the second permeate and fraction C.

In some embodiments, the method comprises sequential crystallization steps and the second retentate is at least partially used in at least one of these other sequential crystallization steps.

In some embodiments, fraction A has a chloride salt concentration higher than or equal to 40 g/L, preferably higher than or equal to 60 g/L, more preferably higher than or equal to 70 g/L and further preferably higher than or equal to 80 g/L.

In some embodiments, fraction B has a chloride salt concentration lower than or equal to 40 g/L, preferably lower than or equal to 30 g/L.

In some embodiments, fraction C has a chloride salt concentration lower than or equal to 30 g/L, preferably lower than or equal to 15 g/L.

In some embodiments, the method further comprises a first resin wash step and a second resin wash step, the two wash steps being performed prior to the step of regenerating the charged resin.

In some embodiments, at the evaporation step, condensates are formed, these condensates being used to conduct the first wash step and/or a final rinse step after regeneration of the charged resin.

In some embodiments, the regeneration of the charged resin also comprises a first elution step and a second elution step, the two elution steps being conducted after the contacting of the charged resin with the regenerant brine.

In some embodiments, the regeneration effluent also comprises fractions D, E and F that have a lower chloride salt concentration than fraction A.

In some embodiments, fraction D has a chloride salt concentration lower than or equal to 5 g/L, and/or fraction E has a chloride salt concentration lower than or equal to 15 g/L, and/or fraction F has a chloride salt concentration lower than or equal to 5 g/L.

In some embodiments, the fractions of regeneration effluent are collected in the following order: D, E, B, A, C, F; and preferably fraction D is used to conduct the second wash step, and/or preferably fraction D is used to conduct the second elution step, and/or preferably fraction E is used to conduct the first elution step, and/or preferably fraction F is used to conduct the first elution step.

In some embodiments, at least 95%, preferably at least 97% and more preferably at least 98% of the chloride salt contained in the regeneration effluent is contained in the final fraction.

In some embodiments, the ratio of the volume of fraction A to the volume of the first retentate is from 10 to 20, preferably from 12 to 16.

In some embodiments, the ratio of the volume of fraction B to the volume of the first retentate is from 1 to 10 and preferably from 3 to 5.

In some embodiments, the evaporation step is conducted in a low-pressure evaporator, preferably using vapor at a pressure of 0.1 to 1 bar absolute.

In some embodiments, the method comprises sequential crystallization steps after which molasses is formed, and the second retentate is at least partially incorporated in this molasses.

The present invention meets the above-expressed need. More particularly, it provides an improved method for sugar processing allowing more efficient recovery of chloride ions on the one hand and colorants on the other hand, from a regeneration effluent, the chloride ions being reused for regeneration, and the colorants being able to be treated or optionally incorporated in the molasses to limit the amount of polluting components, water wastage and the cost of the different steps of the method.

This is achieved with a sugar treatment method comprising steps of recycling the regeneration effluent, the recycling steps comprising a nanofiltration step, a diafiltration step and an evaporation step. More specifically, the regeneration effluent is obtained after regeneration of the ion exchange resin in several fractions (at least three fractions A, B, C). One of these fractions (fraction A) therefore undergoes nanofiltration to obtain a first permeate and a first retentate. This fraction (fraction A) has the highest concentration of chloride salt with a concentration for example of approximately 80 g/L chloride salt. The first permeate is then mixed with another fraction of the regeneration effluent (fraction C) having a lower concentration of chloride salt than fraction A. This mixture is then evaporated to obtain a concentrated chloride salt fraction (called final fraction). Additionally, to overcome the problem of steam consumption mentioned above, the present invention advantageously allows use of the vapor formed during sugar production and more particularly during a crystallization step, to evaporate the brines. The energy cost can therefore be avoided.

The first retentate is diluted with another fraction of the regeneration effluent (fraction B) to undergo a nanofiltration which allows a second permeate and a second retentate to be obtained. The second permeate is combined with the first permeate and with fraction C, before the above-mentioned evaporation, which gives the final fraction that can be used to provide the regenerant brine. By means of this method, more than 95% and preferably more than 98% of salt can be recovered and recycled, which allows a reduction in the quantity of fresh brine to be added. Therefore, with this method it is possible to maximize the quantity of recovered salt (first permeate, second permeate) and at the same time to maximize the quantity of colorants (first retentate, second retentate). The two components are therefore well separated and can be reused separately. In addition, other fractions of regeneration effluent (D,E,F) with low salt concentration can preferably also be used for the resin regeneration steps. The invention therefore not only allows limiting of the quantity of polluting components but also a reduction in water consumption.

Preferably, the method of the invention does not have recourse to any electrodialysis step.

In the invention:

Dilution due to diafiltration is less penalizing than if the nanofiltration permeate were concentrated by electrodialysis rather than evaporation, since reduced conductivity leads to lesser productivity by electrodialysis.

Nanofiltration and evaporation of the brines are well proven technologies on industrial scale, unlike the combination of nanofiltration and electrodialysis for the proposed application as described in document FR 3 005 428.

The frequency of electrodialysis membrane replacement is difficult to estimate in the absence of an industrial reference at the current time, contrary to the case for nanofiltration membranes already widely used in this sector. Technical diagnosis to determine damage to electrodialysis membranes and the need for their replacement is also a source of uncertainty.

The cleaning effluents of membranes of nanofiltration, reverse osmosis or electrodialysis, called secondary effluents (so-called primary effluents represent the effluents leaving ion exchange) are the only effluents that are not recyclable in the decolorization process on resin since they contain residues of chemical additives. The method of the invention produces significantly less thereof than in document FR 3 005 428.

The method of the invention is simpler to operate than the method in document FR 3 005 428 which comprises more processing and recycling steps. The evaporator of the nanofiltration permeate operating at low pressure is particularly simple and reliable for a concentration of the order of 100 g/L, similar to seawater desalination units used on cargo ships.

Electrodialysis uses strong electrical power in the form of a high voltage and direct current. Suitable protection must be provided for operators when installing this type of unit, which can give rise to problems in the setting of sugar refining factories. This problem is eliminated with the method of the invention.

### BRIEF DESCRIPTION OF THE FIGURES

FIG. 1 schematically illustrates concentrations of salt (X) and colorants (Y) of different fractions of a regeneration effluent (along the Y-axis in g/L) as a function of volume flow (along the X-axis in BV for resin bed volume).

### DETAILED DESCRIPTION

A more detailed nonlimiting description of the invention is now given.

The invention concerns a method for treating sugar and more specifically it sets out to recycle a regeneration effluent used to regenerate an ion exchange resin after a sugar purification step on the resin.

More particularly, at this purification step a colored sugar juice is decolorized. By “colored sugar juice” is meant a liquid flow containing sugars and impurities, and in particular molecules of colorants. The colored sugar juice is advantageously derived from the sugar industry. It may have undergone one or more pre-treatment steps such as steps of centrifugation, filtration carbonatation, flotation and/or clarification.

By “decolorization” is meant a reduction in the coloring of the colored sugar juice, measured in ICUMSA units. Methods for determining color derive from official ICUMSA methods adapted for brown sugars: GS1/3-7 (2011) and white sugars: GS2/3-10 (2011)—depending on the origin and type of sugar juice.

The colorants contained in colored sugar juice can be selected from among flavonoids, melanins, carotenes, chlorophylls, xanthophylls, melanoidins, caramels, alkaline degradation products of hexoses (HADPs) and combinations thereof.

Advantageously, the colored sugar juice to which the method of the invention is applied has coloring greater than or equal to 100 IU (ICUMSA units), preferably 300 IU or higher, more preferably 400 IU or higher and further preferably 500 IU or higher.

Further advantageously, the decolorized sugar juice derived from the method of the invention has coloring lower than or equal to 1000 IU preferably lower than or equal to 400 IU, more preferably lower than or equal to 300 IU, further particularly lower than or equal to 200 IU and ideally lower than or equal to 150 IU.

Advantageously, the decoloring rate of the sugar juice (ratio between the coloring of the decolorized sugar juice and the coloring of the sugar juice before application of the decolorizing process, the colorings being measured in IU) is higher than or equal to 30%, or 40%, or 50%, or 60% or 70%.

Decolorization can be performed either in a single-reactor ion exchange system or in an ion exchange system having several reactors.

It may or may not be a static bed ion exchange system. In a static bed ion exchange system, the mixture of compounds to be purified percolates through a chamber or reactor that is generally cylindrical. The reactor contains a bed of porous material (stationary phase) permeable to fluids.

It is possible to carry out said treatment in several reactors in series or in parallel. If the product is treated in a single pass, it percolates through a single reactor. For dual passing, it percolates through two reactors placed in series. A multi-column system can also be cited such as described in document WO 2007/144522.

In the invention, decolorization is performed by placing the colored sugar juice in contact with an ion exchange resin contained in the ion exchange reactor. Preferably, it is a strong anionic resin in chloride form. The resin used may comprise an acrylic or styrenic matrix.

The contacting of the colored sugar juice with the resin allows adsorption of the colorant molecules on said resin. Preferably the colorants are adsorbed on the resin at a flow rate of 1 to 4 BV/h (BV corresponding to resin bed volume equivalents).

The contacting of the colored sugar juice with the resin can be performed for example by percolating the colored sugar juice in the ion exchange reactor.

Alternatively, the contacting of the sugar juice with the resin can performed by placing the resin in suspension in the sugar juice, for example by mixing the resin with the sugar juice in an agitated vessel. In this case, the resin is in a non-compact state. The “compact” state is defined as being a state in which the particles are in permanent or quasi-permanent contact with neighboring particles. The ion exchange resin is then in the form of particles of Dv50 size less than or equal to 200 μm. After contacting, the decolorized sugar juice and charged resin can be separated. A detailed description of this method is given in document WO 2018/096272 to which reference is expressly made.

This step can be conducted at a temperature of 40 to 90° C., preferably from 55 to 85° C., more preferably from 70 to 80° C.

After the contacting step of the resin with the colored sugar juice, a decolorized sugar juice is obtained whereas the resin is henceforth charged with colorants.

At this stage, the decolorized sugar juice can comprise from 30 to 50% of water.

The decolorized sugar juice can then be evaporated. Evaporation is preferably carried out under vacuum. The evaporation step allows a concentrated sugar juice to be obtained called a “syrup” having a concentration of solids (sugar) of approximately 65 to 75% with 25 to 35% of water.

The syrup can then be subjected to one or more crystallizations to give a crystallized sugar. Therefore, at least one crystallization can be carried out at which the syrup is evaporated to become saturated with sugars, and crystals (or crystallized sugar) start to form. At the end of the first crystallization, the crystals can be recovered and the remaining syrup can undergo other sequential crystallizations to give different grades of crystallized sugar. On completion of sequential crystallizations, what is left of the syrup is called “molasses” and can be used by the food industry, for perfumery and pharmaceutical preparations, and to produce biofuel.

After the decolorization step, the charged resin comprises a quantity of sugar juice that has remained in the ion exchange reactor. Preferably, before continuing regeneration of the resin, one or more wash steps can be carried out to eliminate the sugar juice remaining in the charged resin.

Therefore, initially, a first wash step (or first washing) can be carried out with a first wash solution. The purpose of this first washing is to remove decolorized sugar juice remaining in the interstitial spaces between the resin particles and also in the resin particles.

Preferably, this first wash solution is water. The first washing can be conducted in particular at a temperature of 40 to 90° C., preferably 60 to 80° C.

In some embodiments, the first wash solution is derived wholly or in part from the sugar treatment process itself via recycling.

This first washing can be conducted in particular by injecting the first wash solution from the top to the bottom into the ion exchange reactor(s) (the production of decolorized sugar juice preferably taking place from the bottom to the top).

Alternatively, if an agitated vessel is used to place the colored sugar juice in contact with the resin, this first washing can be carried out by placing the charged resin in suspension in the first wash solution and by filtering. It is also possible to cause the first wash solution to pass directly through the compact resin bed which is retained for example on the filter(s).

At the end of this step, a first aqueous sugar solution can be recovered. This solution can be used for example at the following steps of evaporation and crystallization and/or at the head of the sugar refining process e.g. at the melt step.

A second wash step (or second washing) can afterwards be carried out with a second wash solution. This second washing can be conducted by injecting the second wash solution from the bottom to the top into the reactor(s). The purpose of this second washing is to remove the impurities remaining in suspension in the reactor(s).

Alternatively, if an agitated vessel is used to contact the colored sugar juice with the resin, this second washing can be conducted by placing the charged resin in suspension in the second wash solution and performing filtration. It is also possible to cause the second wash solution to pass directly through the compact resin bed which is retained for example on the filter(s).

The second wash solution can be an aqueous solution, preferably saline. Preferably it can have a low chloride salt concentration. This concentration can be lower than or equal to 5 g/L and preferably lower than or equal to 3 g/L. For example, this concentration can be from 0.5 to 1 g/L; or from 1 to 2 g/L; or from 2 to 3 g/L; or from 3 to 4 g/L; or from 4 to 5 g/L.

In some embodiments, the second wash solution is derived wholly or in part from the preceding sugar treatment process in particular from a preceding regeneration step, via recycling.

This second solution can have a temperature of 40 to 90° C., and preferably from 60 to 80° C.

At the end of this step, a second aqueous solution with highly diluted sugar content can be recovered. This solution can be used at the following steps of evaporation and crystallization and/or at the head of the sugar refining process such as at the melt step. It can be used separately or in a mixture with the first aqueous sugar solution.

As mentioned above, the sugar treatment method of the invention also provides for regeneration steps of the resin charged with colorants.

These steps allow the removal of all or part of the colorant molecules adsorbed on the resin, allowing reuse of the latter. For this purpose, the resin is contacted with one or more regenerant solutions.

At a first stage, a regeneration step of the charged resin is conducted with an aqueous solution of chloride salt herein called “regenerant brine”. Preferably this solution has an initial chloride salt concentration of 90 to 110 g/L, preferably about 100 g/l. The chloride salt is preferably selected from among sodium chloride (NaCl), potassium chloride (KCl) and the mixture thereof. More preferably, the chloride salt is NaCl. In preferred embodiments, this solution is a basic solution which, in addition to the chloride salt, may contain sodium hydroxide (NaOH) preferably at a concentration of 10 g/L. The addition of NaOH or of another base allows an increase in the pH of the solution and improves elution of the colorants. Preferably, the regenerant brine has a pH of 9 to 13.

In some embodiments, during the regeneration step, from 150 to 200 g of chloride salt are used per liter of resin, and preferably from 160 to 190 g of chloride salt per liter of resin. Thus, during the regeneration step from 150 to 155 g of chloride salt can be used; or 155 to 160 g of chloride salt; or 160 to 165 g of chloride salt; or 165 to 170 g of chloride salt; or 170 to 175 g of chloride salt; or 175 to 180 g of chloride salt; or 180 to 185 g of chloride salt; or 185 to 190 g of chloride salt; or 190 to 195 g of chloride salt; or 195 to 200 g of chloride salt per liter of resin.

In some embodiments, during the regeneration step, from 2 to 20 g of NaOH are used per liter of resin, and preferably from 5 to 10 g of NaOH per liter of resin. Thus, during the regeneration step, it is possible to use from 10 to 12 g of NaOH; or 12 to 14 g of NaOH; or 14 to 16 g of NaOH; or 16 to 18 g of NaOH; or 18 to 20 g of NaOH per liter of resin.

In some embodiments, the regenerant brine is derived wholly or in part from the sugar treatment process in particular from a preceding regeneration step, via recycling.

The regenerant brine can have a temperature of 40 to 80° C. and preferably 50 to 60° C.

A first elution step (first elution) with a first eluting solution, following the regeneration with the regenerant brine, can be performed. Preferably, the first eluting solution is an aqueous solution, preferably saline. It can therefore have a chloride salt concentration lower than or equal to 15 g/L and preferably lower than or equal to 5 g/L, more preferably lower than or equal to 3 g/L. For example, this concentration can be from 0.5 to 3 g/L; or 3 to 5 g/L; or 5 to 7 g/l; or 7 to 9 g/l; or 9 to 11 g/l; or 11 to 13 g/L; or 13 to 15 g/L.

In some embodiments, the first eluting solution is derived wholly or in part from the sugar treatment process, in particular from a preceding regeneration step, via recycling.

The first eluting solution can have a temperature of 40 to 80 and preferably 50 to 60° C.

Next, a second elution step can take place using a second eluting solution. Preferably, the second eluting solution has a lower chloride salt concentration than the chloride salt concentration of the first eluting solution.

The second eluting solution can be an aqueous solution preferably saline. Preferably, it can have a low chloride salt concentration. This concentration can be lower than or equal to 5 g/L. For example, this salinity can be from 05 to 1 g/L; or 1 to 2 g/L; or 2 to 3 g/L; or 3 to 4 g/L; or 4 to 5 g/L.

In some embodiments, the second eluting solution is derived wholly or in part from the sugar treatment process, in particular from a preceding regeneration step, via recycling.

The second eluting solution can have a temperature of 40 to 80, preferably 50 to 60° C.

At the end of these elution steps (or salt displacement) the ion exchange resin is regenerated and a flow of aqueous solution is obtained and collected after the regeneration called “regeneration effluent”.

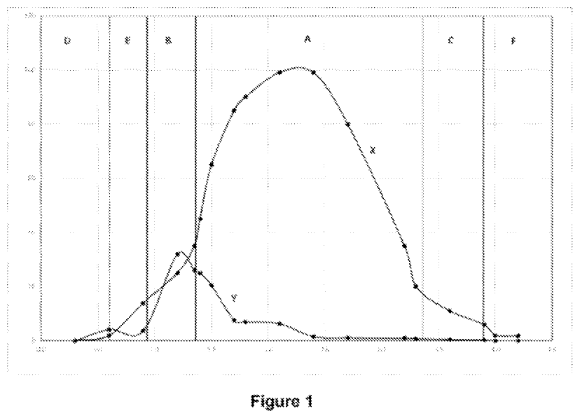

The regeneration effluent may comprise chloride ions derived from the chloride salt and colorants desorbed from the resin. A typical elution profile of the regeneration effluent leaving the reactor is illustrated in FIG. 1. The regeneration effluent may comprise (in reactor elution order):

a first fraction (fraction D) (in the illustrated example, from 0 to 0.6 BV) having a low concentration of colorants and salt;

a second fraction (fraction E) (in the illustrated example from 0.6. to 0.9 BV) having a higher salt concentration than the first fraction, and having a colorant concentration which can be lower than, equal to, or higher than, preferably higher than that of the first fraction;

a third fraction (fraction B) (in the illustrated example from 0.9 to 1.4 BV) having a higher salt concentration than the second fraction, and a higher colorant concentration than the second fraction:

a fourth fraction (fraction A) (in the illustrated example from 1.4 to 3.4 BV) having a higher salt concentration than the third fraction, and a lower colorant concentration than the second fraction;

a fifth fraction (fraction C) (in the illustrated example from 3.4 to 3.9 BV) having a lower salt concentration than the fourth fraction, and a lower colorant concentration than the fourth fraction (or near-zero colorant concentration); and

a sixth fraction (fraction F) (in the illustrated example from 3.9 to 4.2 BV) having a lower salt concentration than the fifth fraction, and a lower colorant concentration than the fifth fraction (or near-zero colorant concentration).

More specifically, about 80 to 90% of the salt of the regenerant brine contained in the total of fractions A to F can preferably be found in fraction A. Fraction A can therefore have a chloride salt concentration higher than or equal to 40 g/L, more preferably higher than or equal to 60 g/L, further preferably higher than or equal to 70 g/L, and still further preferably higher than or equal to 80 g/L. For example, this concentration can be from 40 to 45 g/L; or 45 to 50 g/L; or 50 to 55 g/L; or 55 to 60 g/L; or 60 to 65 g/L; or 65 to 70 g/L; or 70 to 75 g/L; or 75 to 80 g/L; or 80 to 85 g/L; or 85 to 90 g/L; or 90 to 95 g/L.

Measurement of chloride salt concentration of a solution (for example of each fraction A to F) can employ measurement of conductivity and/or degrees Brix. The value of conductivity or of degrees Brix than only needs to be plotted on a calibration curve to determine the chloride salt concentration of the solution.

Fraction A can also have a colorant concentration of 1 to 10 g/L and preferably 3 to 7 g/L. For example, this colorant concentration can be from 1 to 2 g/L; or 2 to 3 g/L; or 3 to 4 g/L; or 4 to 5 g/L; or 5 to 6 g/L; or 6 to 7 g/L; or 7 to 8 g/L; or 8 to 9 g/L; or 9 to 10 g/L.

Measurement of colorant concentration can be performed by Chemical Oxygen Demand (COD) in accordance with standard NF T90-101.

In the entire present description, the concentration of a fraction corresponds to the mean concentration of all the collected volume in the fraction under consideration.

The other fractions of the regeneration effluent (fractions B, C, D, E, F), as indicated in FIG. 1, overall comprise from 10 to 20% of the salt of the regenerant brine.

Fraction D can have a chloride salt concentration lower than or equal to 5 g/L; and preferably lower than or equal to 3 g/L. For example, this concentration can be from 0.5 to 1 g/L; or 1 to 2 g/L; or 2 to 3 g/L; or 3 to 4 g/L; or 4 to 5 g/L.

Fraction D can also have a colorant concentration lower than or equal or 10 g/L, preferably lower than or equal to 5 g/L. For example, this colorant concentration can be from 1 to 3 g/L; or 3 to 5 g/L; or 5 to 7 g/L; or 7 to 9 g/L; or 9 to 10 g/L.

Fraction E can have a chloride salt concentration lower than or equal to 15 g/L; preferably lower than or equal to 10 g/L. For example, this concentration can be from 1 to 3 g/L; or 3 to 5 g/L; or 5 to 7 g/L; or 7 to 9 g/L; or 9 to 11 g/L; or 21 to 13 g/L; or 13 to 15 g/L.

Fraction E can also have a colorant concentration lower than or equal to 10 g/L and preferably lower than or equal to 5 g/L. For example, this color concentration can be from 1 to 3 g/L; or 3 to 5 g/L; or 5 to 7 g/L; or 7 to 9 g/L; or 9 to 10 g/L.

Fraction B can have a chloride salt concentration lower than or equal to 40 g/L, preferably lower than or equal to 30 g/L. For example, this concentration can be from 1 to 5 g/L; or 5 to 10 g/L; or 10 to 15 g/L; or 15 to 20 g/L; or 20 to 25 g/L; or 25 to 30 g/L; or 30 to 35 g/L; or 35 to 40 g/L.

Fraction B can also have a colorant concentration lower than or equal to 35 g/L; and preferably lower than or equal to 25 g/L. For example, this colorant concentration can be from 1 to 5 g/L; or 5 to 10 g/L; or 10 to 15 g/L; or 15 to 20 g/L; or 20 to 25 g/L; or 25 to 30 g/L; or 30 to 35 g/L.

Fraction C can have a chloride salt concentration lower than or equal to 30 g/L, preferably lower than or equal to 15 g/L. For example, this concentration can be from 1 to 5 g/L; or 5 to 10 g/L; or 10 to 15 g/L or 15 to 20 g/L.

Fraction C can also have a colorant concentration lower than or equal to 2 g/L, and preferably lower than or equal to 1 g/L. For example, this colorant concentration can be from 0 to 0.5 g/L; or 0.5 to 1 g/L; or 1 to 1.5 g/L; or 1.5 to 2 g/L.

Fraction F can have a chloride salt concentration lower than or equal to 5 g/L. For example, this concentration can be from 0.5 to 1 g/L; or 1 to 2 g/L; or 2 to 3 g/L; or 3 to 4 g/L.

Fraction F can also have a colorant concentration lower than or equal to 0.5 g/L. For example, this colorant concentration can be from 0 to 0.1 g/L; or 0.1 to 0.2 g/L; or 0.2 to 0.3 g/L; or 0.3 to 0.4 g/L; or 0.3 to 0.4 g/L.

The method of the invention sets out to recycle the regeneration effluent to form the regenerant brine used in the sugar treatment method to regenerate the resin. For this purpose, fraction A of the regeneration effluent i.e. the most concentrated fraction undergoes a nanofiltration step to obtain a first permeate on the one hand and a first retentate on the other hand. The purpose of this nanofiltration is to separate the salt from the colorants by means of their size difference. The first permeate therefore has a chloride salt concentration essentially identical to that of fraction A and is depleted and preferably free (or almost free) of colorants. The first retentate also has a chloride salt concentration essentially identical to that of fraction A but it is enriched with colorants.

In some embodiments, during this step, at least one part of the formed first retentate can be added to the remaining fraction A (which has not yet been filtered) to limit fouling of the nanofiltration membrane and to ensure sufficient tangential velocity on the surface of the membrane.

In some embodiments, the ratio of the volume of fraction A to the volume of the first retentate can be from 10 to 20, and preferably 12 to 16. For example, this ratio can be from 10 to 12; or 12 to 14; or 14 to 16, or 16 to 18; or 18 to 20. This ratio is called the “Volume Concentration Factor” (VCF).

The first retentate derived from nanofiltration then undergoes diafiltration comprising a dilution step of the first retentate in an aqueous solution and a nanofiltration step. In this case, the solution used for dilution is fraction B of the regeneration effluent.

In some preferred embodiments, the nanofiltration step of the first retentate diluted with fraction B is conducted in the same nanofiltration unit as used for fraction A.

In other embodiments, the nanofiltration step of the first retentate diluted with fraction B is conducted in a unit differing from the unit used for nanofiltration of fraction A.

Preferably, each nanofiltration step is batch processed.

At the end of this step, a second permeate and a second retentate are obtained. This step allows the recovery of part of the chloride salt present in the first retentate and also the recovery of the chloride salt present in fraction B in the second permeate. This step therefore allows more complete separation between the chloride salt and colorants which are now contained in the second retentate.

In some embodiments, the ratio of the volume of fraction B to the volume of the first retentate is 1 to 10 and preferably 3 to 5. For example, this ratio can be from 1 to 2; or 2 to 3; or 3 to 4 or 4 to 5; or 5 to 6; or 6 to 7; or 7 to 8; or 8 to 9, or 9 to 10. This ratio is called “diafiltration rate”.

The first permeate derived from nanofiltration is mixed with the second permeate derived from diafiltration and with fraction C of the regeneration effluent. This mixture is evaporated to give a final fraction with concentrated chloride salt content. This step therefore allows an increase in salt concentration by recovering the salt derived from fractions less concentrated than fraction A and having scarce colorant content.

This evaporation can preferably be conducted in a low-pressure evaporator. By “low-pressure evaporator” is meant an evaporator operating at a temperature lower than 100° C. and at pressure lower than 1 bar. This evaporator can be a single-effect or multiple-effect evaporator. A “single-effect evaporator” (as opposed to a multiple-effect evaporator) is one in which the generated vapor is not reused. This vapor can either be discharged into the atmosphere, or condensed (cooling water condenser or mixed condenser), or undergo other treatment. The heating means of said evaporator is generally steam.

To avoid the energy cost of this step, the vapor generated during one of the steps of the sugar treatment method and more particularly the vapor formed during a syrup crystallization step can be used to supply the heat needed for evaporation.

Evaporation can be conducted using previously generated vapor at a pressure of 0.1 to 1 bar absolute, and preferably 0.2 to 0.3 bar absolute. For example, this pressure can be from 0.1 to 0.2 bar; or 0.2 to 0.3 bar; or 0.3 to 0.4 bar; or 0.4 to 0.5 bar.

Evaporation can be conducted using previously generated vapor being at a temperature of 45 to 100° C.; and preferably from 60 to 70° C. For example, the evaporation temperature can be from 45 to 60° C.; or 60 to 70° C.; or 70 to 75° C.; or 75 to 80° C.; or 85 to 90° C.; or 90 to 95° C.; or 95 to 100° C.

In addition, the condensates produced during the evaporation step can then be used in the sugar treatment method. More specifically, the condensates can be used wholly or in part at the above-described first wash step of the resin. Therefore, the first wash solution may comprise or consist of condensates derived from the evaporation step.

Alternatively, the condensates formed at the evaporation step can be used to perform a final rinse step after regeneration of the charged resin.

In some preferred embodiments, the final fraction has a chloride salt concentration of 90 to 110 g/L, and for example of about 100 g/l. Therefore, the final fraction can optionally be used as such as regenerant brine without the addition of fresh brine.

In other embodiments, fresh brine can be added to the final fraction to form the regenerant brine.

In some embodiments, at least 95%, preferably at least 97% and more preferably at least 98% of the chloride salt contained in the regeneration effluent (from the total of fractions A to F) is contained in the final fraction. For example, about 95%, or about 96% or about 97%, or about 98% or about 99% or more than 99% of the chloride salt contained in the regeneration effluent (from the total of fractions A to F) is contained in the recycled regenerant brine.

Due to the improved separation between the colorants and the salt, the second retentate obtained after diafiltration can then be incorporated in the molasses formed during the production of sugar.

Alternatively, the second retentate can be mixed with the syrup remaining after crystallization, for subjection to sequential crystallizations to give different grades of crystallized sugar as described above.

The method of the invention also allows to recycle and reuse of the fractions of regeneration effluent which were not used for the formation of the concentrated fraction.

Therefore, fraction D and/or fraction E and/or fraction F of the regeneration effluent can be used in the sugar treatment method.

Fraction D can be used wholly or in part in the second wash step of the resin. Therefore, the second wash solution may comprise or consist of fraction D.

Fraction D can also be used wholly or in part in the second elution step of the resin. Therefore, the second elution solution may comprise or consist of fraction D derived from a preceding sugar treatment process.

Preferably, part of fraction D is used in the second wash step of the resin, and another part of fraction D is used in the second elution step of the resin.

Fraction E can be used wholly or in part in the first elution step of the resin. Also, the first elution solution may comprise or consist of fraction E.

Fraction F can also be used wholly or in part in the first elution step of the resin. Also, the first elution solution may comprise or consist of fraction F.

In some embodiments, at least one of fraction E and fraction F is used in the first elution step of the resin.

In other embodiments, fraction E and fraction F are mixed and used in the first elution step of the resin.

The recycling of all fractions A to F collected after regeneration of the charged resin allows reducing to zero the liquid effluent discharges derived from this regeneration (effluents also called primary effluents). Solely residual effluents, called secondary and derived from the washing effluents of nanofiltration membranes, are produced and in significantly lesser amount than the method in document FR 3 005 428.

1. A method for treating sugar comprising:
placing a colored sugar juice in contact with an ion exchange resin to charge the resin with colorants and to collect a decolorized sugar juice;
regenerating the colorant-charged resin, comprising:
placing the charged resin in contact with a regenerant brine comprising a chloride salt; and
collecting a regeneration effluent, the regeneration effluent comprising at least three fractions A, B and C, fraction A having a higher chloride salt concentration than fractions B and C; and
recycling the regeneration effluent, comprising:
nanofiltration of fraction A of the regeneration effluent to obtain a first permeate and a first retentate;
diafiltration of the first retentate, this diafiltration comprising:
dilution of the first retentate with fraction B of the regeneration effluent;
nanofiltration of the mixture to obtain a second permeate and a second retentate;
mixing the first permeate with the second permeate and with fraction C of the regeneration effluent, and evaporating this mixture to obtain a final fraction; and
using the final fraction to provide a regenerant brine.

2. The method of claim 1, wherein the chloride salt is selected from among sodium chloride, potassium chloride and mixture thereof.

3. The method of claim 1, further comprising at least one crystallization step of the decolorized sugar juice, during which vapor is generated which is then used to conduct the evaporation step of the mixture of the first permeate with the second permeate and fraction C.

4. The method of claim 3, comprising steps of sequential crystallization and wherein the second retentate is at least partly used in at least one of these other sequential crystallization steps.

5. The method of claim 1, to wherein fraction A has a chloride salt concentration higher than or equal to 40 g/L.

6. The method of claim 1, wherein fraction B has a chloride salt concentration lower than or equal to 40 g/L.

7. The method of claim 1, wherein fraction C has a chloride salt concentration lower than or equal to 30 g/L.

8. The method of claim 1, further comprising a first resin wash step and a second resin wash step, the two wash steps being conducted prior to the regeneration step of the charged resin.

9. The method of claim 8, wherein at the evaporation step condensates are formed, these condensates being used to conduct the first wash step and/or a final rinse step after regeneration of the charged resin.

10. The method of claim 1, wherein regeneration of the charged resin also comprises a first elution step and a second elution step, the two elution steps being conducted after the contacting of the charged resin with the regenerant brine.

11. The method of claim 1, wherein the regeneration effluent further comprises fractions D, E and F having a lower chloride salt concentration than fraction A.

12. The method of claim 11, wherein fraction D has a chloride salt concentration lower than or equal to5 g/L, and/or fraction E has a chloride salt concentration lower than or equal to 15 g/L, and/or fraction F has a chloride salt concentration lower than or equal to 5 g/L.

13. The method of claim 11, wherein the fractions of regeneration effluent are collected in the following order: D, E, B, A, C, F.

14. The method of claim 1, wherein at least 95% of the chloride salt contained in the regeneration effluent is contained in the final fraction.

15. The method of claim 1, wherein the ratio of the volume of fraction A to the volume of the first retentate is from 10 to 20.

16. The method of claim 1, wherein the ratio of the volume of fraction B to the volume of the first retentate is from 1 to 10.

17. The method of claim 1, wherein the evaporation step is conducted in a low-pressure evaporator.

18. The method of claim 1, comprising sequential crystallization steps after which molasses is formed, and wherein the second retentate is at least partly incorporated in this molasses.

19. The method of claim 13, wherein fraction D is used to conduct the second wash step, and/or fraction D is used to conduct the second elution step, and/or fraction E is used to conduct the first elution step, and/or fraction F is used to conduct the first elution step.

20. The method of claim 17, wherein the evaporation step is conducted using vapor at a pressure of 0.1 to 1 bar absolute.
